(19) United States
(12) Patent Application Publication
(10) Pub. No.: US 2023/0277402 A1
(43) Pub. Date: Sep. 7, 2023

(54) ROTATABLE FIXATION BRIDGE

(71) Applicant: Mazor Robotics Ltd., Caesarea (IL)

(72) Inventors: Elad Ratzabi, Ramat Gan (IL); Yonatan Ushpizin, Glil Yam (IL); Yuval Chen, Tel Aviv-Yafo (IL); Dany Junio, Tel Aviv-Yafo (IL)

(21) Appl. No.: 18/003,144

(22) PCT Filed: Jun. 24, 2021
(86) PCT No.: PCT/IL2021/050775

§ 371 Date: Dec. 22, 2022

Related U.S. Application Data
(60) Provisional application No. 63/044,535, filed on Jun. 26, 2020.

(51) Int. Cl. A61G 13/12; A61G 13/00

(52) U.S. Cl. CPC A61G 13/1285; A61G 13/0054; A61G 13/1295

(57) ABSTRACT

A rotatable fixation bridge as described herein may include a first end fixedly connectable to a reference and defining at least a portion of a first joint; a second end fixedly connectable to an anchor and defining at least a portion of a second joint; and a bridge member extending between and rotatably secured to the first end and the second end, the bridge member rotatable relative to an axis and comprising a central portion offset from the axis.

### FIELD

The present technology is generally related to surgical hardware, and is more specifically related to hardware for preventing movement of a patient during a surgical procedure.

### BACKGROUND

During a surgical procedure, a patient is often positioned on an operating table or in a chair. Whether due to normal bodily functions (including voluntary and involuntary processes and/or reactions) or external stimuli such as surgical intervention, one or more anatomical features of the patient may move relative to the operating table or chair, relative to another external reference, and/or relative to another anatomical feature.

Surgical procedures may involve the use any number of surgical tools, including tools configured for cutting, grinding, roughing, cleaning, and otherwise interacting with soft and/or hard tissue, as well as tools configured for use with implant insertion. Such tools may be, for example, held and manipulated by a surgeon, held by a passive mechanical fixture or a robotic arm while being manipulated by a surgeon, held and manipulated by a robotic arm controlled by a surgeon, or held and manipulated by a robotic arm under autonomous control.

### SUMMARY

A rotatable fixation bridge according to one embodiment of the present disclosure comprises: a first end fixedly connectable to a reference and defining at least a portion of a first joint; a second end fixedly connectable to an anchor and defining at least a portion of a second joint; and a bridge member extending between and rotatably secured to the first end and the second end, the bridge member rotatable relative to an axis and comprising a central portion offset from the axis.

At least one of the first joint and the second joint may comprise a ball and socket. The central portion may be arranged substantially parallel to the axis. The central portion may be curved. The first end may comprise a bridge adaptor. The bridge adaptor may comprise a locking screw. The bridge member maintains a relative position of the first end to the second end independent of a rotational position of the bridge member relative to the first end and the second end. The bridge member may comprise a radiolucent material. The radiolucent material may be polyetheretherketone. The bridge member may comprise an end portion substantially perpendicular to the central portion.

A fixation system according to another embodiment of the present disclosure comprises a rotatable fixation bridge. The rotatable fixation bridge comprises: a reference interface fixedly securable to a reference; an anchor interface fixedly securable to an anchor; and a bridge member. The bridge member comprises: a first end portion rotatably secured to the reference interface; a second end portion rotatably secured to the anchor interface; and a central portion extending between the first end portion and the second end portion, the central portion offset from an axis of rotation of the bridge member.

At least one of the reference interface and the anchor interface may comprise a ball or a socket. The bridge member may be configured to maintain a constant relative position of the reference interface and the anchor interface independent of a rotational position of the bridge member about the axis. The at least the central portion of the bridge member may be fashioned of a radiolucent material. The reference interface may comprise a ball and an adaptor configured to partially define a socket that retains the ball. The reference may be one of a surgical robot, a structure for supporting a patient, or a portion of a building. The fixation system may further comprise the anchor, and the anchor may be fixedly attachable to a portion of a patient's spine.

A method of securing a spine to an external reference according to yet another embodiment of the present disclosure comprises: fixedly securing an anchor interface of a rotatable fixation bridge to an anchor; fixedly securing a reference interface of the rotatable fixation bridge to an external reference; rotating a bridge member of the rotatable fixation bridge to a first angular position relative to the anchor interface and the reference interface without changing a position of the anchor interface relative to the reference interface, the bridge member comprising a central portion offset from an axis of rotation of the bridge member; and rotating the bridge member to a second angular position different than the first angular position without changing the position of the anchor interface relative to the reference interface.

Fixedly securing the reference interface to the external reference may comprise fixedly securing a bridge adaptor to the external reference. Fixedly securing the anchor interface to the anchor may comprise fixedly securing a ball of the anchor interface into a socket of the anchor.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X₁-Xₙ, Y₁-Yₘ, and Z₁-Zₒ, the phrase is intended to refer to a single element selected from X, Y, and Z, a combination of elements selected from the same class (e.g., X₁ and X₂) as well as a combination of elements selected from two or more classes (e.g., Y₁ and Zₒ).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments, and configurations of the disclosure are possible utilizing, alone or in combination, one or more of the features set forth above or described in detail below.

Numerous additional features and advantages of the present invention will become apparent to those skilled in the art upon consideration of the embodiment descriptions provided hereinbelow.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed, description of the various aspects, embodiments, and configurations of the disclosure, as illustrated by the drawings referenced below.

FIG. 1 depicts a fixation system according to at least one embodiment of the present disclosure;

FIG. 2 depicts a fixation system according to at least another embodiment of the present disclosure;

FIG. 3 provides an exploded perspective view of a rotatable fixation bridge according to at least one embodiment of the present disclosure; and

FIG. 4 is a flowchart of a method according to at least one embodiment of the present disclosure.

### DETAILED DESCRIPTION

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the methods of this disclosure may be performed by a combination of units or modules associated with, for example, a computing device and/or a medical device (including a medical imaging device).

In one or more examples, one or more steps of the described methods, processes, and techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), general purpose microprocessors (e.g., Intel Core i3, i5, i7, or i9 processors; Intel Celeron processors; Intel Xeon processors; Intel Pentium processors; AMD Ryzen processors; AMD Athlon processors; AMD Phenom processors; Apple A10 or 10X Fusion processors; Apple A11, A12, A12X, A12Z, or A13 Bionic processors; or any other general purpose microprocessors), application specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure. Also, unless explicitly stated otherwise, terms such as “about” and “approximately” when used in connection with a stated value mean within ten percent of the stated value.

Embodiments of the present disclosure may be useful for any surgical procedure. During spine surgery, to take just one example, segmental motion of vertebrae may reduce guidance accuracy when using guided stereotactic systems such as robotics or navigation. Bone-mounted platforms or other anchors connected to the spinal anatomy and to the reference system may be used for restraining such relative motion. Bone-mounted platforms or other anchors may include spinous process clamps or pins, PSIS pins and bridge-type instruments. The reference system may include one or more navigation references and/or table mounted robotic systems.

During robotic and/or navigated spinal surgeries, desired tool trajectories may collide with a bone-mounted platform and thus prevent or eliminate the introduction of instruments or implants to the spine anatomy. Additionally, a bone-mounted platform may block a surgeon's line of sight to the anatomy, or the navigation system's line of sight to a navigation reference.

A rotatable fixation bridge as described herein is designed to maintain bridge end positions while allowing rotation of the middle portion of the bridge, so that collisions of the bridge with desired tool trajectories, and/or line of sight issues, may be reduced or avoided altogether. Rotation of the middle portion of the bridge maintains the position of the anatomical feature relative to the reference to which it is connected.

As described more fully below, a rotatable fixation bridge according to at least some embodiments of the present disclosure may be rigid, may include two concentric rotational hinges, may be made of a radiolucent material (e.g., polyetheretherketone, or PEEK) or thermoplastic resins with carbon-fiber reinforcement, may be designed for cleaning and sterilization so as to allow re-use, and may comprise one or more portions of one or more ball and socket joints to facilitate adjustability thereof.

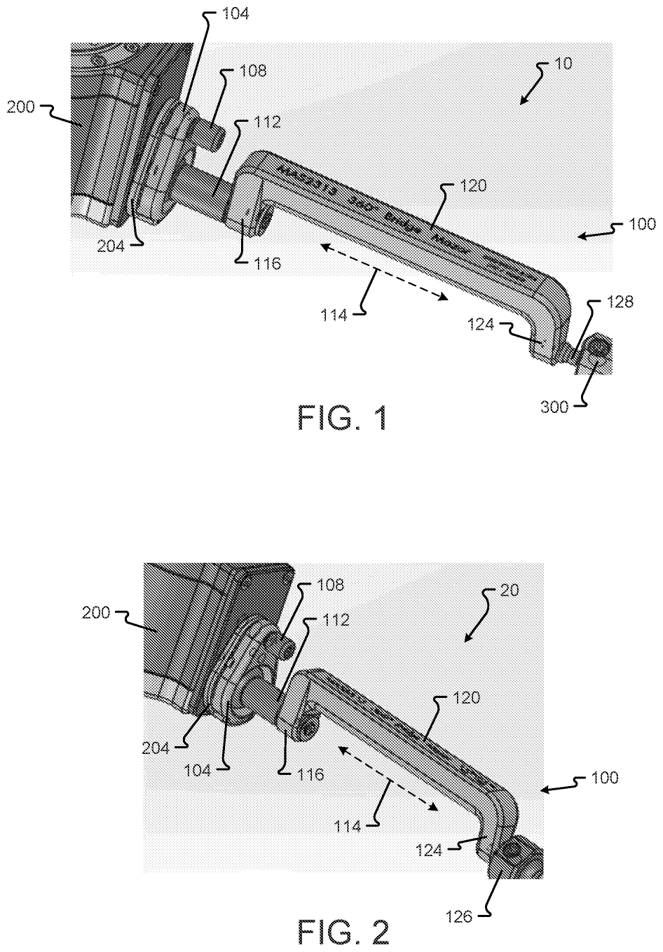

With reference first to FIG. 1, a fixation system 10 according to at least one embodiment of the present disclosure comprises a rotatable fixation bridge 100, a reference 200, and an anchor 300. The system 10 may be used to secure an anatomical feature of a patient to the reference 200, so as to beneficially maintain or substantially maintain a relative position of the anatomical feature of the patient and the reference 300 during a surgical procedure.

The anchor 300—which may be any known bone-mounted platform or anchor, including, for example, a clamp (e.g., a spinous process clamp), a screw (e.g., a Schanz screw), a pin (e.g., a spinous process pin, a PSIS pin), and/or a bridge-type instrument—may be secured to one or more vertebra of a spine or to any other anatomical element suitable for receiving the anchor 300. The anchor 300 may securely grip one or more outside surfaces of the anatomical feature, and/or may extend into and/or through the anatomical feature. The anchor 300 may, in some embodiments, be threaded into the anatomical feature. The anchor 300 provides a rigid connection between the rotatable fixation bridge 100 and the anatomical feature.

The reference 200 may be, for example, a surgical robot or a component thereof. In some embodiments, the reference 200 is a base of a surgical robot, which may comprise one or more robotic arms extending from the base and usable in connection with a surgical procedure on the patient. In such embodiments, the surgical robot may operate autonomously, or based (whether in whole or in part) on user input from a surgeon or other user. Successful operation of the surgical robot may depend on the surgical robot maintaining a known, fixed (or at least substantially fixed) position relative to the patient, or to a target anatomical feature of the patient, or to a surgical site within the patient. The target anatomical feature may or may not be the anatomical feature to which the anchor 300 is attached.

In some embodiments, the reference 200 may be a structure supporting the patient, such as an operating table or chair, a platform, or any other structure. The reference 200 may alternatively be a ceiling, wall, floor, or any other portion of a building. In such embodiments, fixation of the patient (or of one or more anatomical features of the patient) may be useful or desired to facilitate proper functioning and/or use of a surgical navigation system, or to maintain a registration between or among two or more of a coordinate system of a surgical navigation system, a separate coordinate system of a patient, and/or another separate coordinate system of a surgical robot. Fixation of the patient (or of one or more anatomical features of the patient) may additionally or alternatively be useful or desired to reduce a risk that the patient will move, whether voluntarily or involuntarily, during a surgical procedure in which significant accuracy and/or precision is desired, regardless of whether the surgical procedure is being carried out by a surgeon, a surgical robot, or a combination thereof.

In some embodiments, the reference 200 may be an anatomical structure of the patient. For example, the pelvis, sacrum, or a lower vertebra of a patient may serve as a reference for a higher vertebra. Thus, in these embodiments, the rotatable fixation bridge 100 provides stability between different anatomical structures while increasing access to the anatomical features around the rotatable fixation bridge 100.

The rotatable fixation bridge 100 comprises a bridge adaptor 104, a locking screw 108, a first extension 112, a first end portion 116, a central portion 120, a second end portion 124, and a second extension 128. A rotatable fixation bridge 100 according to other embodiments of the present disclosure may comprise more or fewer components than those described herein with respect to FIG. 1.

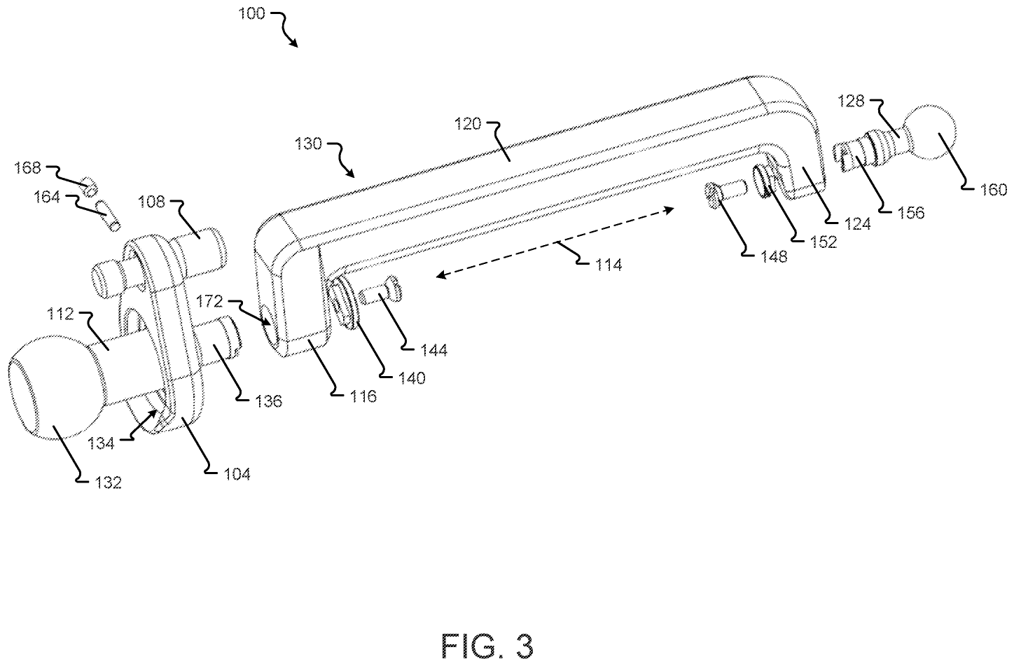

The bridge adaptor 104 may be shaped to complement a mount 204 of the reference 200. More specifically, the bridge adaptor 104 may comprise a plate or member shaped to receive or be received by the mount 204. The bridge adaptor 104 may be made of any metal, metal alloy, plastic, or other material, or any combination thereof, suitable for fixedly securing the rotatable fixation bridge 100 to the reference 200. The bridge adaptor 104 may comprise one or more locking screws 108 for fixedly securing the bridge adaptor 104 to the mount 204 and thus to the reference 200. Additionally or alternatively, the bridge adaptor 104 may be configured to attach to the mount 204 via a press fit, a snap fit, an interlocking fit, or any other attachment method and/or mechanism. The bridge adaptor 104 may form or define at least a portion of a socket in which a ball (such as the first ball 132 of FIG. 3) of the rotatable fixation bridge 100 is received and secured.

The first extension 112 extends between a ball or other object or mechanism fixedly secured to the reference 200 by the bridge adaptor 104, and the first end portion 116. Notably, the attachment between the first extension 112 and the first end portion 116 does not permit axial or translational movement of the first end portion 116 relative to the first extension 112, but does permit relative rotational movement. In other words, when the bridge adaptor 104 is secured to the reference 200, the first extension 112 is fixedly secured relative to the reference 200, but the first end portion 116 may rotate around the first extension 112 (and thus around an axis 114 defined at least in part by the first extension 112).

In some embodiments, the first end portion 116 may be lockable in a specific angular position relative to the first extension 112, whether by way of one or more complementary protrusions and detents along an interface between the first extension 112 and the first end portion 116, or using a pin and/or a set screw, or due to friction between the first extension 112 and the first end portion 116, or otherwise.

The central portion 120 connects the first end portion 116 to the second end portion 124 to form a bridge member. The central portion 120 is offset from the axis of rotation 114 of the bridge member. The axis 114 may be defined, for example, by the coaxial axes of the first extension 112 and the second extension 128. In some embodiments, rotational hinges other than those illustrated in FIG. 1 (comprising a cylindrical first extension 112 received by an aperture in a first end portion 116, and a cylindrical second extension 128 received by an aperture in a second end portion 124, respectively) may be utilized by the rotatable fixation bridge 100. In such embodiments, the rotational hinges of the rotatable fixation bridge 100 may be concentric and/or coaxial, and may define the axis 114 of rotation of the rotatable fixation bridge 100.

The central portion 120 may be substantially straight or linear, as shown in FIG. 1. The central portion 120 may be substantially parallel to the axis 114 of rotation, as also shown in FIG. 1. In some embodiments, the central portion 120 may not be substantially parallel to the axis 114 of rotation. For example, the central portion 120 may continuously curve from the first end portion 116 to the second end portion 124. In such embodiments, the central portion 120 may have a constant radius of curvature, or a varying radius of curvature. The central portion 120 may comprise a curve that extends in substantially the same plane as the first end portion 116 and the second end portion 124, or the curve may extend in a different plane. In other words, the central portion 120 may curve in a plane that is parallel to but does not include the axis of rotation 114. In still other embodiments, the central portion 120 may comprise one or more curved portions, and/or one or more straight portions.

In some embodiments, whether a bridge member of the rotatable fixation bridge 100 comprising a straight central portion 120 or comprising a curved central portion 120 is selected for use in connection with a given surgical procedure may depend on the nature of the surgical procedure. For example, a curved central portion 120 may beneficially provide a large obstacle-free area in between the first end portion 116 and the second end portion 124 than a straight central portion 120, and may therefore be more desirable when the rotatable fixation bridge 100 will extend, for example, directly over a surgical site.

In some embodiments, the central portion 120 may not be readily distinguishable (e.g., whether by a change of angle or curvature or otherwise) from the first end portion 116 and the second end portion 124. In other embodiments, the central portion 120 may be perpendicular to at least a portion of the first end portion 116 and/or to at least a portion of the second end portion 124.

The central portion 120 may be offset from the axis 114 by a maximum distance—as measured between the axis 114 and a surface of the central portion 120 that faces the axis 114—of about half of one inch, or of about one inch, or of about two inches, or of about three inches. In some embodiments, the central portion 120 may be offset from the axis 114 by a maximum distance in a range between about one half-inch and about twelve inches, or in a range between about one inch and about eight inches, or in a range between about one inch and about five inches. Notwithstanding the foregoing, the present disclosure encompasses rotatable fixation bridges 100 having a central portion 120 offset from an axis 114 by any distance.

The amount of offset of the central portion 120 relative to the axis 114 may be determined in whole or in part by a length of the first end portion 116 and of the second end portion 124 (e.g., when the central portion 120 is straight or linear, as shown in FIG. 1), or by a radius of curvature of the central portion 120 (e.g., when the central portion 120 is curved), or by a combination of the foregoing. In some embodiments, the first end portion 116 and the second end portion 124 may be adjustable between or among a plurality of lengths in a direction substantially perpendicular to the axis 114, so as to increase or decrease an offset of the central portion 120 relative to the axis 114. In such embodiments, the first and second end portions 116 and 124 may be fixedly securable or lockable at each of the plurality of lengths, so that once set at a particular length, the length of the first and second end portions 116 and 124 does not inadvertently change. The first and second end portions 116 and 124 according to such embodiments may comprise one or more telescoping members, and/or one or more folding members, and/or one or more selectively attachable or detachable members.

The central portion 120 may have a length of between about one inch and about thirty inches, or a distance of between about two inches and about twenty inches, or a distance of between about three inches and twelve inches. The central portion 120 may be about sixteen inches long, or about twelve inches long, or about eight inches long. In some embodiments, the central portion 120 may be adjustable between or among a plurality of lengths. In such embodiments, the central portion 120 may be fixedly securable or lockable at each of the plurality of lengths, so that once set at a particular length, the length of the central portion 120 does not inadvertently change. A central portion 120 according to such embodiments may comprise one or more telescoping members, and/or one or more folding members, and/or one or more selectively attachable or detachable members.

The central portion 120 may be or comprise a hand grip, so that a surgeon or other user may grip the central portion 120 and cause the central portion 120 to rotate about the axis 114 between a first rotational position and a second rotational position. As noted above, in some embodiments, the central portion 120 (together with the first end portion 116 and the second end portion 124) may be lockable in a plurality of rotational or angular positions relative to the first extension 112 and the second extension 128 (and thus relative to the reference 200, the anchor 300, and the patient to which the anchor 300 is secured). In such embodiments, the central portion 120 (together with the first end portion 116 and the second end portion 124) may be set at a first angular or rotational position and locked in place to prevent further unintentional movement thereof, and then unlocked, moved to a second angular or rotational position, and again locked in place to prevent further unintentional movement thereof.

In some embodiments of the present disclosure, the central portion 120 (together with the first end portion 116 and the second end portion 124) may be held in a given angular or rotational position about the axis 114 with a frictional fit only (rather than with, for example, a mechanical locking mechanism).

FIG. 2 illustrates a fixation system 20 substantially similar to the fixation system 10, except that the second end portion 124 of the rotatable fixation bridge 100 comprises a socket 126. The socket 126 is fixedly secured to the second end portion 124, and is configured to receive a ball that is rigidly secured to an anchor. In other words, whereas the rotatable fixation bridge 100 of the fixation system 10 comprises a second extension 128 supporting a ball (e.g., the second ball 160 of FIG. 3) that is received by a socket in the anchor 300, the rotatable fixation bridge 100 of the fixation system 20 comprises a socket 126 adapted to receive (and secure in a fixed position) a ball of an anchor such as the anchor 300.

Use of mechanical ball and socket joints to secure the rotatable fixation bridge 100 to a reference 200 and/or to an anchor 300 beneficially enables the rotatable fixation bridge 100 to be oriented as needed, independent of the location of the anchor 300 (and thus of the anatomical feature of the patient to which the anchor 300 is fixedly connected) relative to the location of the reference 200. In other words, provided that the mount 204 generally faces the anchor 300 (or that a ball or socket of the anchor 300 generally faces the mount 204), the rotatable fixation bridge may be positioned to extend from the mount 204 and toward the anchor 300 (or from the anchor 300 and toward the mount 204) at any one of a plurality of angles. In contrast, if the rotatable fixation bridge 100 were only fixedly securable to the mount 204 and/or to the anchor 300 at one angle, or at one of a few predetermined angles, then the reference 200 and the anchor 300 could only be secured to each other in a corresponding one or a corresponding few relative positions. This, in turn, might result in an increased workload for the surgeon and/or other user(s) of the fixation systems 10 and/or 20, who may need to spend extra time positioning the reference 200 relative to the anchor 300 so that a rotatable fixation bridge 100 may be secured therebetween.

Notwithstanding the foregoing, the present disclosure encompasses fixation systems in which the rotatable fixation bridge 100 is fixedly secured to the reference 200 and/or to the anchor 300 using a mechanical ball and socket joint, a hinge joint, a saddle joint, or any other joint or attachment mechanism that is or can be fixed or secured in at least one specific position. In some embodiments, at least a portion of any such joint (e.g., a ball, or a socket) may be part of the rotatable fixation bridge 100.

FIG. 3 illustrates an exploded view of a rotatable fixation bridge 100 according to at least some embodiments of the present disclosure. The rotatable fixation bridge 100 of FIG. 3 includes the bridge adaptor 104; the locking screw 108; the first extension 112; a bridge member 130 comprising the first end portion 116, the central portion 120, and the second end portion 124; and the second extension 128, all as described above. Also shown in FIG. 3 are a first ball 132, an aperture 134, a rotation mount 136 of the first extension 112, caps 140 and 152, screws 144 and 148, a rotation mount 156 of the second extension 128, a second ball 160, a pin 164, a set screw 168, and an aperture 172.

Each of the first ball 132 and the second ball 160 is adapted to be received by a corresponding socket. The first ball 132 is configured to be received by a socket of a reference 200, which may be at least partially defined by a mount 204 on or in the reference 200. The socket may also be at least partially defined by the bridge adaptor 104, such that when the bridge adaptor 104 is secured to the mount 204, a complete socket is defined, with the first ball 132 secured therein. A pin 164, driven by a set screw 168, is configured to extend through the bridge adapter 104 and into the socket that receives the first ball 132, so as to engage the first ball 132 and lock the first ball 132 in a fixed position relative to the reference 200. In some embodiments, a plurality of pins 164, set screws 168, and/or other devices may be used to lock the first ball 132 in a specific orientation within the socket. Also in some embodiments, the bridge adaptor 104 is configured to lock the first ball 132 in a specific orientation within the socket, once the bridge adaptor 104 is secured to a mount 204 (or otherwise secured to the reference 200).

The bridge adaptor 104 comprises an aperture 134 that is sized to allow the first extension 112 to pass therethrough, but to prevent passage of the first ball 132 therethrough. The aperture 134 thus defines an opening of the socket that receives the first ball 132, and enables the first ball 132 to be secured within the socket while still being connected (e.g., via the first extension 112) to the first end portion 116.

The first extension 112 is rotatably secured to the first end portion 116 via the rotation mount 136. The rotation mount 136 is a cylindrical portion of the first extension 112 sized to fit within a corresponding aperture 172 of the first end portion 116. The rotation mount 136 has a diameter less than a maximum width or diameter of the first extension 112. With the rotation mount 136 extending through the aperture 172, the cap 140 may be secured to the rotation mount 136 with the screw 144. Once so assembled, the wider portion of the first extension 112 and the cap 140 abut the axial sides (e.g., the sides perpendicular to the axis 114) of the first end portion 116 and prevent translational motion of the first end portion 116 (relative to the first extension 112) in a dimension parallel to the axis 114, while the rotation mount 136 prevents translational motion of the first end portion 116 (relative to the first extension 112) in any other dimension. However, the first end portion 116 may still rotate around the rotation mount 136.

Similarly, the second ball 160 is configured to be received by a socket of an anchor 300. One or more set screws or other devices (not shown) may be used to lock the second ball 160 in a specific orientation within the socket of the anchor 300.

The second extension 112 is rotatably secured to the second end portion 124 via the rotation mount 156. The rotation mount 156 is a cylindrical portion of the first extension 112 sized to fit within a corresponding aperture (not visible in FIG. 3) of the second end portion 124. The rotation mount 156 has a diameter less than a maximum width or diameter of the second extension 128. With the rotation mount 156 extending through the aperture of the second end portion 124, the cap 144 may be secured to the rotation mount 156 with the screw 148. Once so assembled, the wider portion of the second extension 116 and the cap 152 abut the axial sides (e.g., the sides perpendicular to the axis 114) of the second end portion 124 and prevent translational motion of the second end portion 124 (relative to the second extension 128) in a dimension parallel to the axis 114, while the rotation mount 156 prevents translational motion of the second end portion 124 (relative to the second extension 128) in any other dimension. However, the second end portion 124 may still rotate around the rotation mount 156.

When assembled, the first ball 132 (together with the first extension 112, the bridge adaptor 104, the locking screw 108, the pin 164, and/or the set screw 168, in some embodiments) defines a first end or a reference interface of the rotatable fixation bridge 100, and the second ball 160 (together with the second extension 128 and any other components of the rotatable fixation bridge 100 useful for securing the second ball 160 to a socket of the anchor 300), in some embodiments) defines a second end or an anchor interface of the rotatable fixation bridge 100. In embodiments of the present disclosure in which one or both of the first ball 132 and the second ball 160 are replaced with a socket, then the socket proximate the first end portion 116 (together with any other components useful for securing a ball of the reference 200 in the socket) would define the first end or reference interface, and the socket proximate the second end portion 124 would define the second end or the anchor interface. Regardless of the joint or attachment mechanism used to secure the rotatable fixation bridge 100 to the reference 200 and/or to the anchor 300, the portion of the rotatable fixation bridge 100 that allows the rotatable fixation bridge 100 to be secured to the reference 200 comprises the first end or the reference interface, and the portion of the rotatable fixation bridge 100 that allows the rotatable fixation bridge 100 to be secured to the anchor 300 comprises the second end or the anchor interface.

Each of the various components of the rotatable fixation bridge 100 may be made of a metal, a metal alloy, a plastic, a composite, any other suitable material that enables the component to achieve the purpose thereof as described herein, and/or any combination of the foregoing. In some embodiments, one or more components of the rotatable fixation bridge 100 may be made of a radiolucent material, such as polyetheretherketone (PEEK), polyetherimide, or thermoplastic resins with carbon-fiber reinforcement. In other embodiments, none of the components of the rotatable fixation bridge 100 are radiolucent. The material(s) from which the various components of the rotatable fixation bridge 100 are made may be selected to enable the rotatable fixation bridge and/or one or more portions thereof to be cleanable, sterilizable (whether by heat, chemical treatment, or otherwise), and/or reusable. Additionally and/or alternatively, the material(s) from which the various components of the rotatable fixation bridge 100 are made may be selected to ensure that the rotatable fixation bridge is strong enough to withstand forces of any expected magnitude during the course of a surgical procedure.

A rotatable fixation bridge as described herein, such as the rotatable fixation bridge 100, beneficially maintains a relative position of the first end thereof (which may be attached to, for example, a surgical robot or other reference) and the second end thereof (which may be attached to, for example, an anchor that is in turn attached to an anatomical feature of a patient), independent of a rotational position of the bridge member relative to the first and second ends. As a result, if the bridge member of the rotatable fixation bridge presents an obstacle to achieving a desired tool trajectory or obtaining a desired image or observing along a desired line of sight during a surgical procedure in which the rotatable fixation bridge is being used, the bridge member may simply be rotated to a different angular position, thus removing the obstacle and permitting the desired tool trajectory to be achieved, or the desired image to be obtained, or the desired line of sight to be observed.

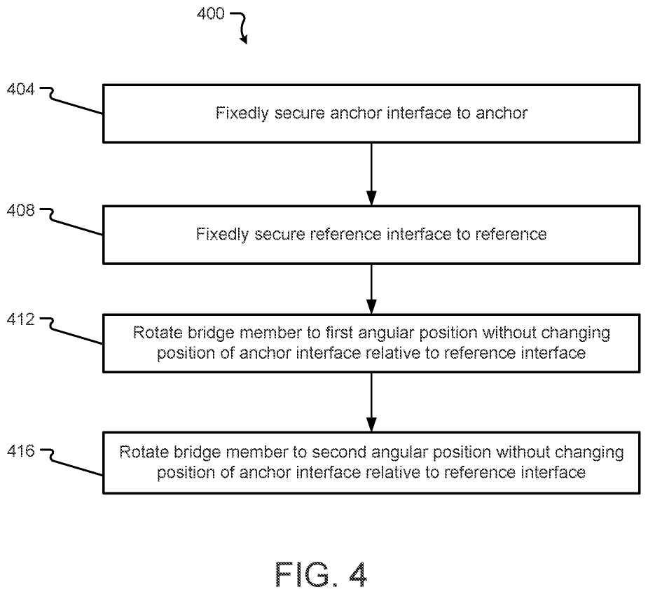

With reference now to FIG. 4, a method 400 of securing an anatomical feature to an external reference comprises fixedly securing an anchor interface of a rotatable fixation bridge to an anchor (step 404). The fixedly securing may comprise fixedly securing a ball of the anchor interface into a socket of the anchor. The fixedly securing may additionally or alternatively comprise securing the anchor interface to the anchor with one or more bolts, screws, or other mechanical fasteners. The anchor may be the same as or similar to the anchor 300 and/or any clamp, screw, or pin described herein, and/or may be any other device that may be fixedly secured to an anatomical feature.

The method 400 further comprises fixedly securing a reference interface of the rotatable fixation bridge to an external reference (step 408). The external reference may the same as or similar to the reference 200, and/or any other reference described herein. The fixedly securing may comprise fixedly securing a ball, such as the first ball 132, into a socket. The fixedly securing may comprise securing bridge adaptor, such as the bridge adaptor 104, to the external reference (or to a mount thereof, such as the mount 204). The fixedly securing may comprise threading a locking screw such as the locking screw 108 through the bridge adaptor and into the external reference, and/or driving a pin such as the pin 164 into the first ball 132 using a set screw such as the set screw 168, so as to secure a ball such as the first ball 132 into a specific position within the socket.

The method 400 further comprises rotating a bridge member of the rotatable fixation bridge to a first angular position relative to the anchor interface and the reference interface (step 412). The bridge member comprises a central portion offset from an axis of rotation of the bridge member. The rotation does not change a position of the anchor interface relative to the reference interface. However, because the bridge member comprises a central portion offset from an axis of rotation of the bridge member, the rotation results in at least the central portion assuming a first position that is unique as compared to the position of at least the central portion when the bridge member is rotated to any other angular position relative to the anchor interface and the reference interface.

The method 400 further comprises rotating the bridge member to a second angular position different than the first angular position (step 416). Here again, the rotation does not change the position of the anchor interface relative to the reference interface, and therefore maintains the position of the anchor (and of the anatomical feature to which the anchor is connected, be it a vertebra or other spinal feature or any other anatomical feature) relative to the reference. Additionally, because the bridge member comprises a central portion offset from the axis of rotation of the bridge member, the rotation results in at least the central portion assuming a second unique position different than the first unique position. As a result, if the bridge member or a portion thereof, when in the first angular position, presents an obstacle to achieving a desired tool trajectory, or to obtaining a desired image, or to any other aspect of a given surgical procedure, the bridge member can be rotated to the second angular position, thus removing the obstacle and enabling the desired tool trajectory to be achieved, the desired image to be obtained, or any other step of the surgical procedure that was inhibited due to the location of the bridge member to be performed.

As may be appreciated based on the foregoing disclosure, the present disclosure encompasses methods with fewer than all of the steps identified in FIG. 4 and the corresponding description, as well as methods that include more steps than those identified in FIG. 4 and the corresponding description. In some embodiments, one or more steps of the method 400 may be repeated one or more times.

Rotatable fixation bridges according to embodiments of the present disclosure, such as the rotatable fixation bridge 100, beneficially enable a bridge member to be moved from at least one first position to at least one second position without affecting a relative position of a reference and an anatomical feature connected to the reference via the bridge member (and, for example, an anchor, and other components of the rotatable fixation bridge). As a result, any registration between the reference and the anatomical feature may be maintained, while saving the time and money that might otherwise be expended by adjusting the relative position of the reference and the anchor/anatomical feature (e.g., to move a non-rotatable bridge out of the way) and then repeating any registration process.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A rotatable fixation bridge comprising:
a first end fixedly connectable to a reference and defining at least a portion of a first joint;
a second end fixedly connectable to an anchor and defining at least a portion of a second joint; and
a bridge member extending between and rotatably secured to the first end and the second end, the bridge member rotatable relative to an axis and comprising a central portion offset from the axis.

2. The rotatable fixation bridge of claim 1, wherein at least one of the first joint and the second joint comprises a ball and socket.

3. The rotatable fixation bridge of claim 1, wherein the central portion is arranged substantially parallel to the axis.

4. The rotatable fixation bridge of claim 1, wherein the central portion is curved.

5. The rotatable fixation bridge of claim 1, wherein the first end comprises a bridge adaptor.

6. The rotatable fixation bridge of claim 5, wherein the bridge adaptor comprises a locking screw.

7. The rotatable fixation bridge of claim 1, wherein the bridge member maintains a relative position of the first end to the second end independent of a rotational position of the bridge member relative to the first end and the second end.

8. The rotatable fixation bridge of claim 1, wherein the bridge member comprises a radiolucent material.

9. The rotatable fixation bridge of claim 8, wherein the radiolucent material is polyetheretherketone.

10. The rotatable fixation bridge of claim 1, wherein the bridge member comprises an end portion substantially perpendicular to the central portion.

11. A fixation system comprising:
a rotatable fixation bridge comprising:
a reference interface fixedly securable to a reference;
an anchor interface fixedly securable to an anchor; and
a bridge member comprising:
a first end portion rotatably secured to the reference interface;
a second end portion rotatably secured to the anchor interface; and
a central portion extending between the first end portion and the second end portion, the central portion offset from an axis of rotation of the bridge member.

12. The fixation system of claim 11, wherein at least one of the reference interface and the anchor interface comprises a ball or a socket.

13. The fixation system of claim 11, wherein the bridge member is configured to maintain a constant relative position of the reference interface and the anchor interface independent of a rotational position of the bridge member about the axis.

14. The fixation system of claim 11, wherein the at least the central portion of the bridge member is fashioned of a radiolucent material.

15. The fixation system of claim 11, wherein the reference interface comprises a ball and an adaptor configured to partially define a socket that retains the ball.

16. The fixation system of claim 11, wherein the reference is one of a surgical robot, a structure for supporting a patient, or a portion of a building.

17. The fixation system of claim 11, further comprising the anchor, and wherein the anchor is fixedly attachable to a portion of a patient's spine.

18. A method of securing a spine to an external reference, comprising:
fixedly securing an anchor interface of a rotatable fixation bridge to an anchor;
fixedly securing a reference interface of the rotatable fixation bridge to an external reference;
rotating a bridge member of the rotatable fixation bridge to a first angular position relative to the anchor interface and the reference interface without changing a position of the anchor interface relative to the reference interface, the bridge member comprising a central portion offset from an axis of rotation of the bridge member; and
rotating the bridge member to a second angular position different than the first angular position without changing the position of the anchor interface relative to the reference interface.

19. The method of claim 18, wherein fixedly securing the reference interface to the external reference comprises fixedly securing a bridge adaptor to the external reference.

20. The method of claim 18, wherein fixedly securing the anchor interface to the anchor comprises fixedly securing a ball of the anchor interface into a socket of the anchor.
